(19) United States
(12) Patent Application Publication
(10) Pub. No.: US 2009/0005971 A1
(43) Pub. Date: Jan. 1, 2009

(54) DELIVERY MAP CREATION METHOD AND DEVICE AND DIFFERENTIAL DATA CREATION METHOD AND DEVICE

(75) Inventor: Kohei Otsuki, Iwaki-city (JP)

Correspondence Address: ALPINE/BHGL, P.O. Box 10395, Chicago, IL, 60610, US

(73) Assignee: ALPINE ELECTRONICS, INC., Tokyo (JP)

(21) Appl. No.: 12/125,696

(22) Filed: May 22, 2008

(30) Foreign Application Priority Data
Jun. 26, 2007 (JP) 2007-167110

(51) Int. Cl. G01C 21/32

(52) U.S. Cl. 701/208

(57) ABSTRACT

In a new map, links not constituting a new road and connected to links constituting the new road, are set as boundary links. Further, in an old map, the same links as the boundary links of the new map are set as boundary links of the old map. Then, in the new map, links connecting between the boundary links are searched for as new road constituent links. Further, in the old map, links connecting between the boundary links are searched for as deletion links. Then, link information of the respective boundary links of the old map data is replaced with link information of the respective boundary links of the corresponding new map data. The link information of the deletion links is then deleted from the old map data, and link information of the new road constituent links is added to the old map data, to thereby create delivery map data.

### PRIORITY CLAIM

This application claims the benefit of Japanese Patent Application No.: 2007-167110, which was filed on Jun. 26, 2007, and which is incorporated by reference herein in its entirety.

### BACKGROUND OF THE INVENTION

1. Field of the Invention

The present invention relates to a delivery map creation method and device and a differential data creation method and device, and particularly to a delivery map creation method for creating delivery map data by adding link information relating to a predetermined new road included in new map data to old map data. A differential data creation method for creating differential data is used to update the old map data to the new map data by using the delivery map data.

2. Description of the Related Art

A navigation device reads map data according to a current location of a vehicle from a recording medium, such as a CD-ROM (Compact Disk-Read Only Memory), a DVD (Digital Versatile Disk), and an HDD (Hard Disk Drive), to draw a map on a display screen. Further, the navigation device fixedly displays a vehicle mark at a fixed position on the display screen, and performs scrolling display of the map in accordance with the driving of the vehicle. The map data includes, for example, (1) road layer information, including node data, road link data, intersection data, and so forth, (2) background layer information for displaying objects on the map, and (3) character layer information for displaying the names of cities, towns, and villages, and so forth. The image of the map displayed on the display screen is generated on the basis of the background layer information and the character layer information. Processes are performed, such as a process of searching for a route from the place of departure to the destination, a process of displaying the route on the map for navigation, and a map matching process, on the basis of the road layer information. In addition to the above-described functions, the navigation device has a variety of functions such as a POI (Points of Interest) display function for displaying a predetermined POI mark on the map, a map zoom in/out function, and a three-dimensional map display function.

The map data stored in the recording medium becomes obsolete over time due to a change in terrain data caused by the construction of a new road or the like, the opening or closing of a facility, the housing land development, and other reasons. In view of this, a conventional technique of controlling navigation has been proposed in which updated map data for each region is stored in a memory of the navigation device to read from the memory the map of a region having the updated map data and to read from the recording medium (e.g., the CD-ROM or the DVD) the map of a region not having the updated map data (see Japanese Unexamined Patent Application Publication No. 2003-337027, for example). According to the conventional technique, however, the navigation control needs to be performed with the use of both the recording medium, such as the CD-ROM, and the DVD and the memory such as the hard disk. Therefore, the control is complicated. Further, in the conventional technique, the map recording medium, such as the CD-ROM and the DVD, is constantly required for the navigation control. Thus, a music CD reproduction device or a DVD reproduction device needs to be provided separately from a map reproduction device. As a result, the number of hardware devices is increased.

In view of the above, another conventional technique has been proposed which performs updating of an old map by extracting the commonalities and differences between the old map and a new map and displays the commonalities and differences on a display device (see Japanese Unexamined Patent Application Publication No. 8-248875). The second conventional technique, however, does not disclose how the map data is specifically updated with the use of the commonalities and differences.

Further, another method has been proposed which records the map data in a map storage unit, such as the HDD, and rewrites the map data of the HDD with the latest map data upon any change in the map data (see Japanese Unexamined Patent Application Publication No. 2004-287705). In the third conventional technique, a user obtains from a central device the differences between the new map data and the old map data, or purchases a difference DVD recorded with the differences between the new map data and the old map data, to thereby update the old map data of the HDD to the new map data. With this configuration, after the update of the map data, the navigation control can be performed with the new map data recorded on the HDD. Further, a DVD reproduction device for listening to music or viewing video can be used as a DVD reproduction device for reproducing a map, and music or video can be enjoyed during the navigation control.

FIG. 12 is a schematic diagram for explaining the production of a difference DVD 1 by a map differential data creation device. The map data contains a multitude of files. Thus, the map differential data creation device (not illustrated) performs, for each of the files, a process of extracting the differences between a new map file NMF of a new version (Ver. 2) and an old map file OMF of an old version (Ver. 1) to create differential data files DFD₁ to DFD_{N}. Thereafter, the map differential data creation device combines all the differential data files DFD₁ to DFD_{N} to create differential data, and writes the differential data on a DVD to produce the difference DVD 1.

FIG. 13 is a diagram for explaining a method of creating the differential data file for each file. Through the comparison between the new map file NMF and the old map file OMF is in byte units, data areas MR1 to MR3 of the old map file OMF matching data areas of the new map file NMF are searched for. Then, (1) the initial addresses and the sizes of the data areas MR1 to MR3 of the old map and (2) data sets A to D of the new map not matching the old map data, are sequentially arranged to create the differential data file. In FIG. 13, each of two-headed arrows indicates an area common to the old and new files. Non-matching area data DLTM of the old map file OMF is discarded, and the non-matching area data sets A to D of the new map file NMF are added to the differential data file as the differential data. Each of the data areas MR1 to MR3 of the old map common to the old and new files is identified with an initial address ADi and a size Si of the area. The differential data file of the example of FIG. 13 is configured as illustrated in FIG. 14. That is, the differential data file is configured to include 1) a portion of the new map file including the data set A, 2) a portion of the old map file specifying the area MR1 (including an initial address. AD₁ and a size S₁ of the area MR1), 3) a portion of the new map file including the data set B, 4) a portion of the old map file specifying the area MR3 (including an initial address AD₃ and a size S₃ of the area MR3), 5) a portion of the new map file including the data set C, 6) a portion of the old map file specifying the area MR2 (including an initial address AD₂ and a size S₂ of the area MR2), and 7) a portion of the new map file including the data set D.

FIG. 15 is a diagram for explaining an updating process of the navigation device for updating the old map data of the HDD to the new map data with the use of the difference DVD. In the updating of a map, a hard disk reading unit 2 of the navigation device reads the old map file OMF of Version 1 (Ver. 1) from a hard disk 3, and inputs the old map file OMF in an update processing unit 4. Further, a DVD reproduction unit 5 reads the differential data file from the difference DVD 1, and inputs the differential data file in the update processing unit 4. Using the differential data file and the old map file OMF of Ver. 1, the update processing unit 4 generates the new map file NMF of Ver. 2 for each file. Then, a hard disk writing unit 6 rewrites the old map file OMF with the new map file NMF.

In the updating of a map according to the third conventional technique, however, the size of the differential data file is increased. Thus, the process of creating the new map file NMF from the old map file OMF and the differential data file takes time. Further, due to a large number of the differential data files, the reproduction of a music CD, a DVD video, or the like is interrupted for a long time. In view of this, the applicant of the present application has proposed a method of reducing the size of the differential data file (Japanese Patent Application No. 2005-361554).

According to this proposed method, a new map is drawn with the new map data, and a replacement area required by the user is specified in the drawn new map. Then, a map data portion included in the replacement area is formed into an additional file, and the map data portion included in the replacement area is deleted from the old map data. Then, the additional file is incorporated in the old map data after the deletion to create delivery map data, and the differential data is created with the use of the delivery map data and the old map data. With this configuration, only the area required by the user, such as the map data portion of a newly opened route, for example, can be formed into the additional file in the navigation control. Accordingly, the size of the differential data can be reduced.

FIG. 16 is a diagram for explaining the principle of the creation of the differential data, wherein delivery map data DLMP is created by using the delivery map data DLMP and old map data OMP to create differential data DFMP necessary for updating the old map data OMP held by the navigation device to new map data NMP.

An additional file creation unit 11 extracts a necessary portion (a newly opened route) from the new map data NMP to create an additional file ADF. An additional file incorporation unit 12 deletes from the old map data OMP the map data of the portion incorporated into the additional file ADF, and incorporates the additional file ADF into the old map data OMP obtained after the deletion of the map data, to thereby create the delivery map data DLMP. The delivery map data DLMP does not completely match the new map data NMP, but includes a change required by the user in the navigation (the change in the route). A differential data creation unit 13 uses the old map data OMP and the delivery map data DLMP to create the difference DVD recorded with the differential data DFMP in accordance with the method described with reference to FIGS. 12 to 14.

FIG. 17 is a diagram for explaining a method of creating and incorporating the additional file ADF for identifying a road portion to be added to the old map data OMP. The additional file creation unit 11 (FIG. 16) draws a new map 21 by using a predetermined new map file NMF including the added portion, and draws an old map 22 by using the corresponding old map file OMF. Then, in the drawn new map 21, the additional file creation unit 11 specifies a replacement area 23 including changed roads, to form a map data portion included in the replacement area 23 into the additional file ADF. The additional file incorporation unit 12 deletes from the old map file OMF the map data portion (a deletion portion) DLF included in the replacement area 23, and incorporates the additional file ADF into an old map file OMF′ obtained after the deletion, to thereby create the delivery map file DLMF.

FIGS. 18A to 20 are diagrams for explaining a method of specifying the replacement area. The replacement area is input in the form of a polygon having an arbitrary shape, as illustrated in FIGS. 18A to 18C. The method of inputting the polygon is performed by inputting the apexes of the polygon or tracing the shape of the polygon on the drawn map with a mouse.

As illustrated in (a) of FIG. 19, the replacement area 23 including the road added portion is assumed to be input such that the outline of the replacement area 23 does not overlap with road nodes and crosses (passes over) road links. Further, as illustrated in (b) of FIG. 19, the additional file ADF includes (1) the roads included in the replacement area 23, (2) the road links crossing the outline of the replacement area 23, and (3) nodes of the road links. The deletion portion DLF (see FIG. 17) deleted from the old map 22 includes (1) the roads included in the replacement area 23 and (2) the road links crossing the outline of the replacement area 23. The nodes which are connected to the road links crossing the outline of the replacement area 23 and which are located outside the replacement area 23 are not deleted.

If the rule for specifying the replacement area 23 is set as described above, it is possible to specify the replacement area 23 so as to reliably include the road added portion. Further, as illustrated in (a) and (b) of FIG. 20, the coordinates of nodes N1 to N6 which are connected to the road links crossing the outline of the replacement area 23 and which are located outside the replacement area 23, basically match between the new map 21 and the old map 22. Accordingly, the additional file ADF illustrated in (c) of FIG. 20 can be easily incorporated into the old map file OMF′ illustrated in (d) of FIG. 20, which is obtained after the deletion, such that the matching nodes N1 to N6 of the additional file ADF overlap with the nodes N1 to N6 of the old map file OMF′.

According to the above-proposed method, however, the replacement area 23 includes a large number of unchanged roads and narrow streets in the vicinity of the newly opened road. In such a case, the additional file ADF includes the data of the unchanged roads and streets, and thus is increased in size. Particularly, if an expressway is newly opened in an urban area, for example, the replacement area 23 includes a large number of unchanged roads, and thus the additional file ADF is increased in size. In the case in which the replacement area 23 includes a large number of unchanged roads, the above-proposed method requires a long time to perform the process of creating the delivery map data and the process of creating the differential data.

### SUMMARY OF THE INVENTION

In view of the above, it is an object of the present invention to have an additional file include only road data relating to a predetermined newly opened road without including therein road data of unchanged roads.

Another object of the present invention is to reduce the size of the additional file to thereby reduce the time required to create delivery map data and create differential data.

Delivery Map Creation Method:

According to a first aspect of the present invention, a delivery map creation method creates delivery map data by adding link information relating to a predetermined new road included in new map data to old map data.

The delivery map creation method includes (1) a step of setting, in a new map, links not constituting the new road and connected to links constituting the new road as boundary links, and setting, in an old map, the same links as the boundary links of the new map as boundary links of the old map, (2) a step of searching, in the new map, for links connecting between the boundary links as new road constituent links, (3) a step of searching, in the old map, for links connecting between the boundary links as deletion links, and (4) a step of replacing link information of the respective boundary links of the old map data with link information of the respective boundary links of the corresponding new map data, deleting link information of the deletion links from the old map data, and adding link information of the new road constituent links to the old map data.

In the above-described delivery map creation method, the step of setting the boundary links may include a step of setting the boundary links of the new map by displaying an area including the new road using the new map data, and specifying predetermined links on the display screen, and a step of setting the boundary links of the old map by displaying the area using the old map data, and specifying predetermined links on the display screen. In this case, the area of the new map and the area of the old map may be displayed in juxtaposition on the display screen with the use of the new map data and the old map data, respectively.

In the above-described delivery map creation method, the step of searching for the new road constituent links may include a step of searching for all routes leading from each of the boundary links of the new map to the other boundary links by using the new map data, and a step of searching for the new road constituent links by extracting the new road constituent links from links constituting the respective routes without causing overlapping of the extracted links.

In the above-described delivery map creation method, the step of searching for the deletion links may include a step of searching for all routes leading from each of the boundary links of the old map to the other boundary links, using the old map data, and a step of searching for the deletion links by extracting the deletion links from links constituting the respective routes without causing overlapping of the extracted links.

In the above-described delivery map creation method, the step of setting the boundary links of the new map may identify, based on nodes at the opposite ends of the boundary links, nodes on the side of the new road constituent links, and the step of searching for the new road constituent links may search for links connecting between the identified nodes of the boundary links, as the new road constituent links.

In the above-described delivery map creation method, the step of setting the boundary links of the old map may identify, based on nodes at the opposite ends of the boundary links, nodes on the side of the deletion links, and the step of searching for the deletion links may search for links connecting between the identified nodes of the boundary links, as the deletion links.

Differential Data Creation Method:

According to a second aspect of the present invention, a differential data creation method is used to update old map data to new map data, and includes (1) a step of creating delivery map data by adding link information relating to a predetermined new road included in the new map data, to the old map data, and (2) a step of creating differential data by identifying an old map data portion in which the delivery map data matches the old map data and identifying a delivery map data portion which is absent in the old map data. The step of creating the delivery map data employs the delivery map creation method according to the first aspect of the present invention.

Delivery Map Creation Device:

According to a third aspect of the present invention, a delivery map creation device creates delivery map data by adding link information relating to a predetermined new road included in new map data, to old map data.

The delivery map creation device includes a boundary link setting unit, a new road constituent link search unit, a deletion link search unit, and a delivery map generation unit. The boundary link setting unit sets, in a new map, links not constituting the new road and connected to links constituting the new road as boundary links, and sets, in an old map, the same links as the boundary links of the new map, as boundary links of the old map. The new road constituent link search unit searches, in the new map, for links connecting between the boundary links as new road constituent links, and stores the new road constituent links. The deletion link search unit searches, in the old map, for links connecting between the boundary links as deletion links, and stores the deletion links. The delivery map generation unit creates a delivery map by replacing link information of the respective boundary links of old map data, with link information of the respective boundary links of the corresponding new map data, deletes link information of the deletion links from the old map data, and adds link information of the new road constituent links to the old map data.

The boundary link setting unit may set the boundary links of the new map by displaying an area including the new road on a display screen with the use of the new map data and specifying predetermined links on the display screen. Further, the boundary link setting unit may set the boundary links of the old map by displaying the area on the display screen with the use of the old map data and specifying predetermined links on the display screen. In this case, the boundary link setting unit may display the area of the new map and the area of the old map in juxtaposition on the display screen with the use of the new map data and the old map data, respectively.

The new road constituent link search unit may search for all routes leading from each of the boundary links of the new map to the other boundary links by using the new map data, and may search for the new road constituent links by extracting the new road constituent links from links constituting the respective routes without causing overlapping of the extracted links. Further, the deletion link search unit may search for all routes leading from each of the boundary links of the old map to the other boundary links by using the old map data, and may search for the deletion links by extracting the deletion links from links constituting the respective routes without causing overlapping of the extracted links.

The boundary link setting unit may identify, based on nodes at the opposite ends of the boundary links, nodes on the side of the new road constituent links, and the new road constituent link search unit may search for links connecting between the identified nodes of the boundary links as the new road constituent links. Further, the boundary link setting unit may identify, based on nodes at the opposite ends of the boundary links, nodes on the side of the deletion links, and the deletion link search unit may search for links connecting between the identified nodes of the boundary links as the deletion links.

Differential Data Creation Device:

According to a fourth aspect of the present invention, a differential data creation device is used to update old map data to new map data, and includes a delivery map creation unit for creating delivery map data by adding link information relating to a predetermined new road included in the new map data, to the old map data. Also included is a differential data creation unit for creating differential data by identifying an old map data portion in which the delivery map data matches the old map data and a delivery map data portion which is absent in the old map data. The delivery map creation unit employs the delivery map creation device according to the third aspect of the present invention.

According to an aspect of the present invention, in the new map, the links not constituting the new road and connected to the links constituting the new road, are set as the boundary links. Further, in the old map, the same links as the boundary links of the new map are set as the boundary links of the old map. Then, with the use of the new map data, the links connecting between the boundary links (the new road constituent links) are searched for to create an additional file. It is therefore possible to prevent the additional file from including redundant road data excluding the links of the newly opened road, and thus it is possible to reduce the size of the additional file. Further, with the use of the old map data, the links connecting between the boundary links (the deletion links) are searched for to create a deletion file. Therefore, the size of the deletion file can be reduced. As a result, the time required to create the delivery map data or the differential data can be reduced.

According to an aspect of the present invention, it is possible to automatically create the delivery map data by replacing the link information of the boundary links of the old map data with the link information of the boundary links of the corresponding new map data, deleting the link information of the deletion links from the old map data, and adding the link information of the new road constituent links to the old map data. Further, it is possible to automatically create the differential data by using the delivery map data.

According to an aspect of the present invention, the area including the new road may be displayed on the display screen by using the new map data, and the predetermined links may be specified on the display screen, to thereby set the boundary links of the new map. Further, the area may be displayed on the display screen with the use of the old map data, and the predetermined links may be specified on the display screen, to thereby set the boundary links of the old map. Accordingly, the boundary links can be easily set. In this case, if the area of the new map and the area of the old map are displayed in juxtaposition on the display screen using the new map data and the old map data, respectively, to set the boundary links, the matching between the boundary links of the new map and the boundary links of the old map can be easily performed.

According to an aspect of the present invention, it is possible to search for all routes leading from each of the boundary links of the new map to the other boundary links by using the new map data, and to automatically search for the new road constituent links by extracting the new road constituent links from the links constituting the respective routes without causing overlapping of the extracted links. Further, according to an aspect of the present invention, it is possible to search for all routes leading from each of the boundary links of the old map to the other boundary links by using the old map data, and to automatically search for the deletion links by extracting the deletion links from the links constituting the respective routes without causing overlapping of the extracted links.

According to an aspect of the present invention, based on the nodes at the opposite ends of the boundary links, the nodes on the side of the new road constituent links may be identified in the setting of the boundary links. Therefore, the new road constituent links can be reliably searched for. Further, according to an aspect of the present invention, based on the nodes at the opposite ends of the boundary links, the nodes on the side of the deletion links may be identified. Therefore, the deletion links can be reliably searched for.

### BRIEF DESCRIPTION OF THE DRAWINGS

FIG. 1 is a configuration diagram of a map updating system for updating old map data;

FIGS. 2A to 2C are diagrams for explaining a delivery map creation process;

FIG. 3 is a diagram for explaining link information for map data;

FIG. 4 illustrates a link shape;

FIG. 5 is a diagram for explaining a link information replacement process, a link information deletion process, and a link information addition process;

FIG. 6 is a configuration diagram of a differential data creation device according to an embodiment of the present invention;

FIGS. 7A and 7B illustrate examples of boundary link information stored in a boundary link storage unit;

FIG. 8 illustrates the flow of a differential data creation process;

FIG. 9 illustrates the flow of a delivery map data creation process;

FIG. 10 illustrates the flow of a process of acquiring new road constituent links (additional links);

FIG. 11 illustrates the flow of a process of acquiring deletion links;

FIG. 12 is a schematic diagram for explaining the production of a difference DVD;

FIG. 13 is a diagram for explaining a method of creating a differential data file for each file;

FIG. 14 is a configuration diagram of the differential data file;

FIG. 15 is a diagram for explaining an updating process of a navigation device for updating old map data to new map data;

FIG. 16 is a diagram for explaining the principle of the creation of differential data;

FIG. 17 is a diagram for explaining a method of creating and incorporating an additional file for identifying a road added portion to be added to the old map data;

FIGS. 18A to 18C are first diagrams for explaining a method of specifying a replacement area;

FIG. 19 is a second diagram for explaining the method of specifying a replacement area; and

FIG. 20 is a third diagram for explaining the method of specifying a replacement area.

### DESCRIPTION OF THE PREFERRED EMBODIMENTS

(A) Overview of Creation of Delivery Map:

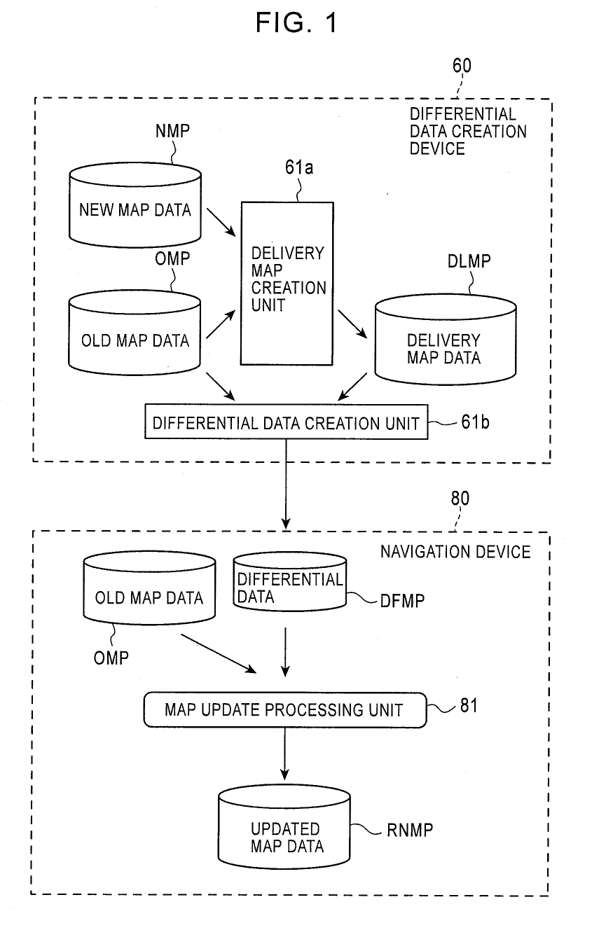

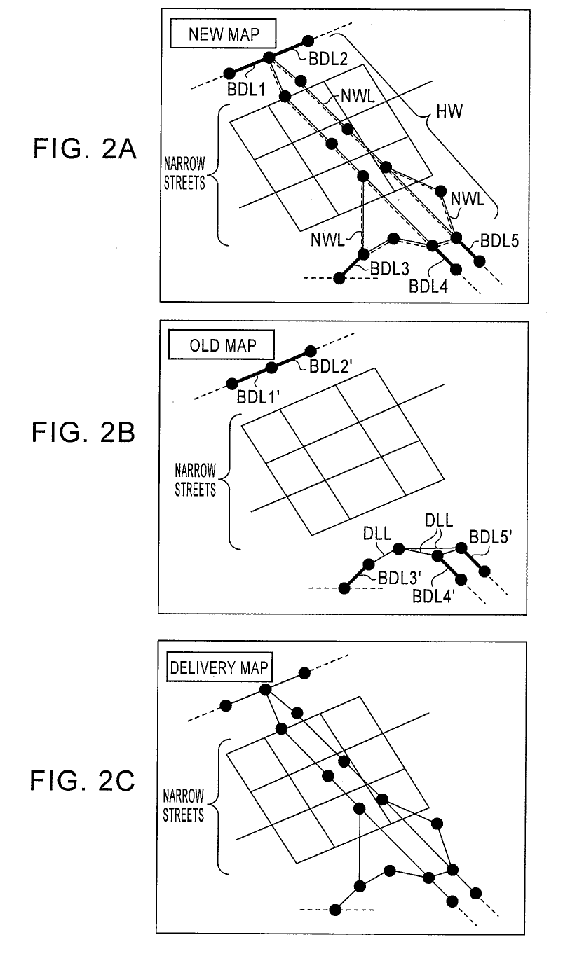

FIG. 1 is a configuration diagram of a map updating system for updating old map data. The map updating system is constituted by a differential data creation device 60 and a navigation device 80. FIGS. 2A to 2C are diagrams for explaining a delivery map creation process. FIG. 2A illustrates a display example in which a road link connection diagram (a road network) of an area, including a newly opened route HW, is generated with the use of new map data and displayed on a monitor. FIG. 2B illustrates a display example in which another road link connection diagram of the area is generated with the use of old map data and is displayed on the monitor. FIG. 2C illustrates a display example in which another road link connection diagram of the area is generated with the use of delivery map data and is displayed on the monitor. In FIG. 2A, links NWL indicated by broken lines constitute new road constituent links constituting the newly opened route (an expressway) HW, and the other links excluding the links indicated by the broken lines constitute roads and narrow streets present in an old map.

In the map updating system of FIG. 1, a delivery map creation unit 61a of the differential data creation device 60 uses new map data NMP to generate the first road link connection diagram (FIG. 2A) of the area including the newly opened route HW, and displays the first road link connection diagram on the monitor. Further, the delivery map creation unit 61a uses old map data OMP to generate the second road link connection diagram (FIG. 2B) of the area, and displays the second road link connection diagram on the monitor in juxtaposition with the first road link connection diagram. Then, if a user specifies links BDL1 to BDL5 (heavy line links) connected to the new road constituent links NWL (the link indicated by the broken lines in FIG. 2A) on the monitor by using a cursor, the delivery map creation unit 61a sets the links BDL1 to BDL5 as boundary links. Further, if links BDL1′ to BDL5′ of the old map, which are the same as the boundary links BDL1 to BDL5 of the new map, are specified with the use of the cursor, the delivery map creation unit 61a sets the links BDL1′ to BDL5′ as boundary links of the old map, and performs matching between the boundary links BDL1 to BDL5 and the boundary links BDL1′ to BDL5′.

Thereafter, the delivery map creation unit 61 a uses the new map data NMP to search for all links connecting between the boundary links BDL1 to BDL5 as the new road constituent links NWL. Further, in the old map, the delivery map creation unit 61a searches for links connecting between the boundary links BDL1′ to BDL5′ as deletion links DLL.

After the completion of the above-described processes, the delivery map creation unit 61 a replaces link information of the respective boundary links BDL1′ to BDL5′ of the old map data OMP with link information of the respective boundary links BDL1 to BDL5 of the corresponding new map data NMP. The delivery map creation unit 61 then deletes link information of the deletion links DLL from the old map data OMP, and adds link information of the new road constituent links NWL to the old map data OMP. From the above-described processes, the delivery map creation unit 61a creates delivery map data DLMP.

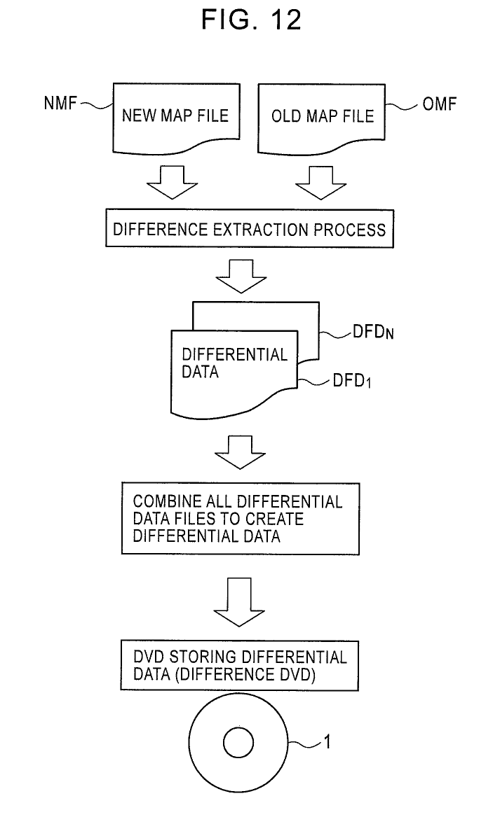

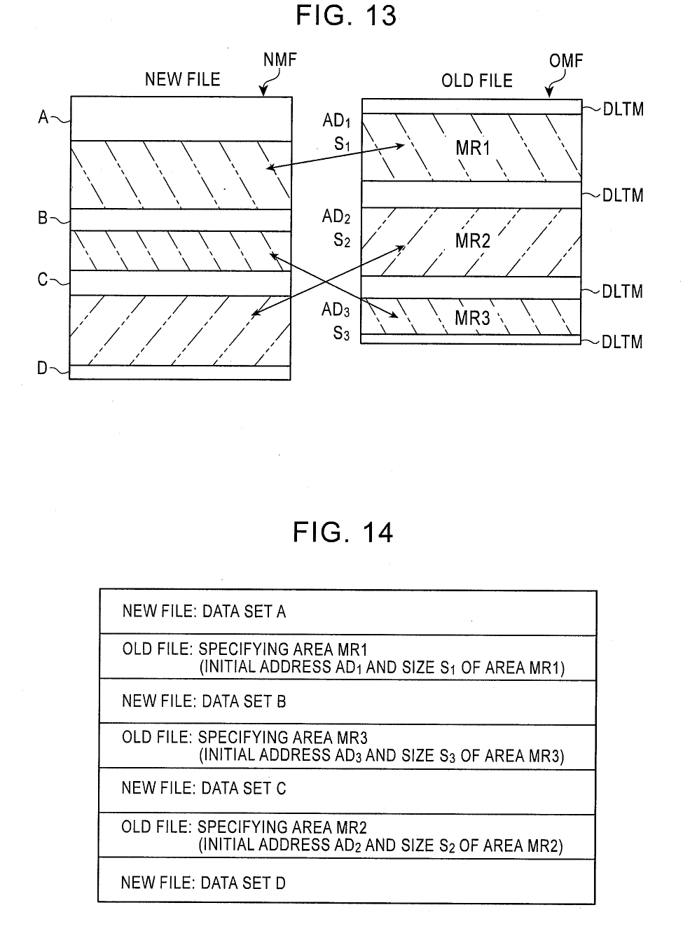

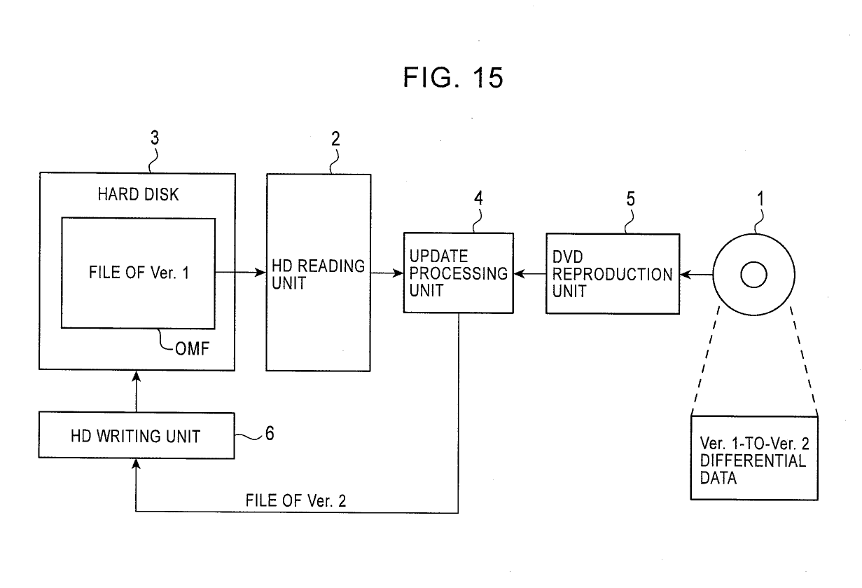

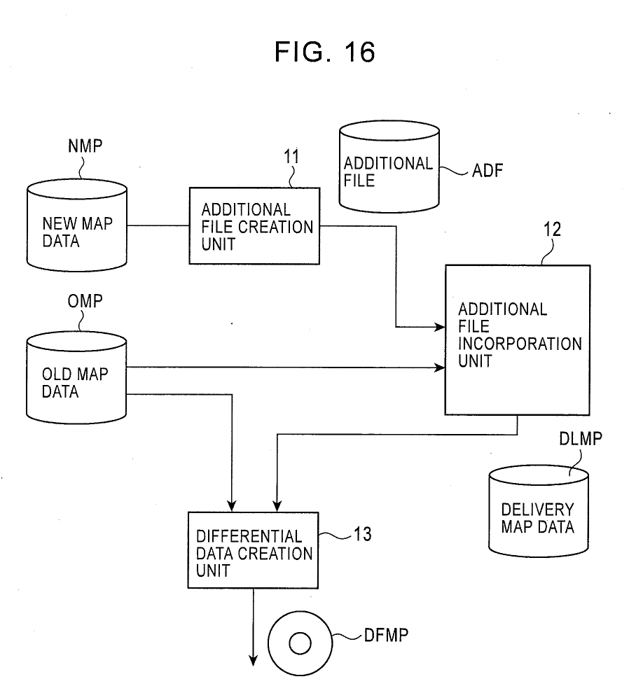

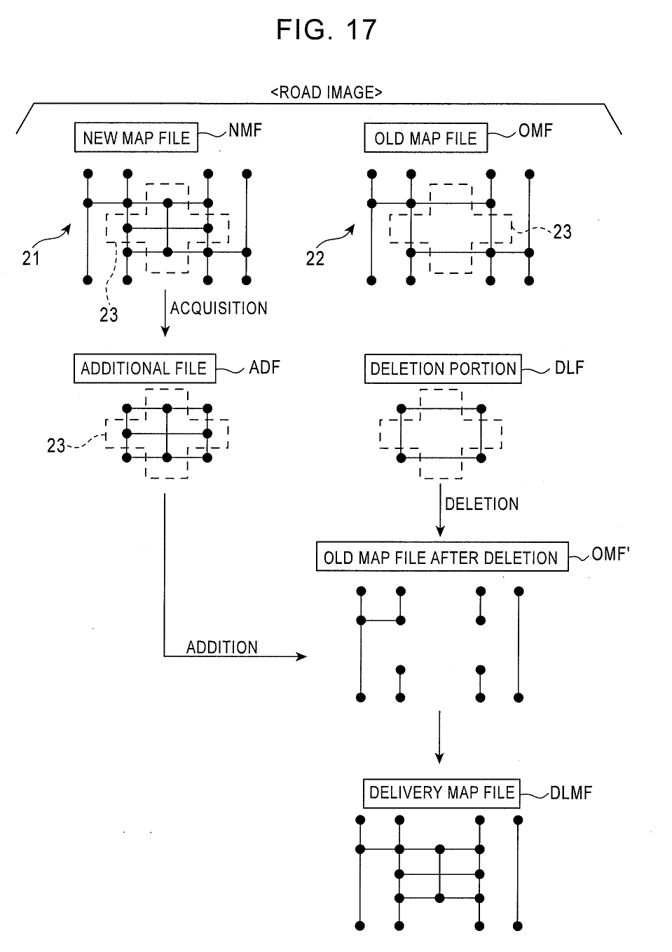

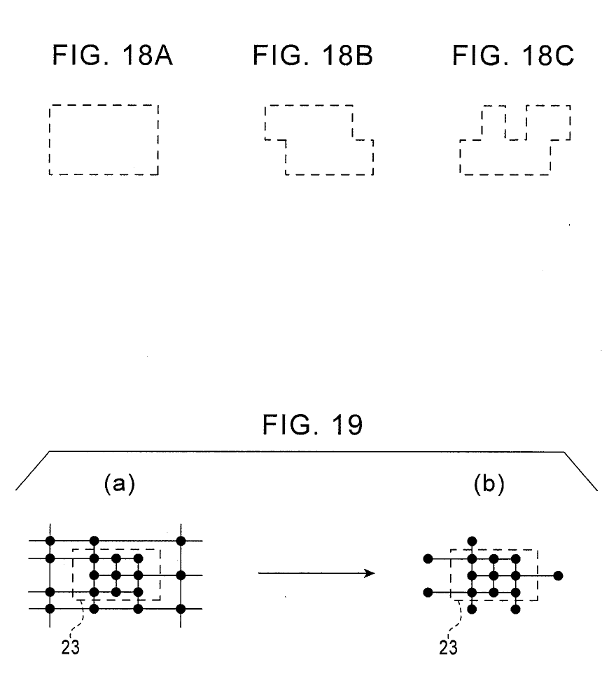

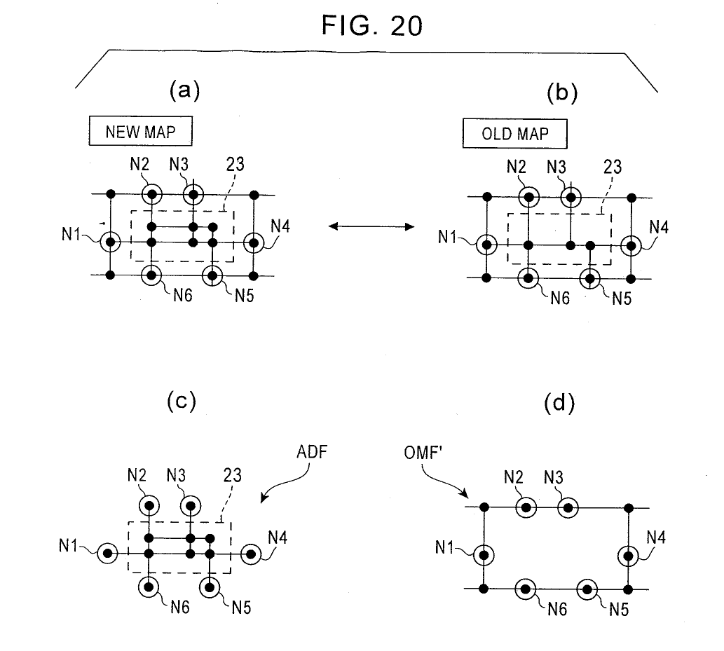

After the completion of the creation of the delivery map data DLMP, a differential data creation unit 61b uses the old map data OMP and the delivery map data DLMP to create differential data DFMP according to the method described with reference to FIGS. 12 to 14, and passes the differential data DFMP to the navigation device 80. A map update processing unit 81 of the navigation device 80 uses the old map data OMP stored in a hard disk device and the differential data DFMP to create route-by-route updated map data RNMP, which reflects the newly opened route HW, according to the method described with reference to FIG. 15.

(B) Link Information Record:

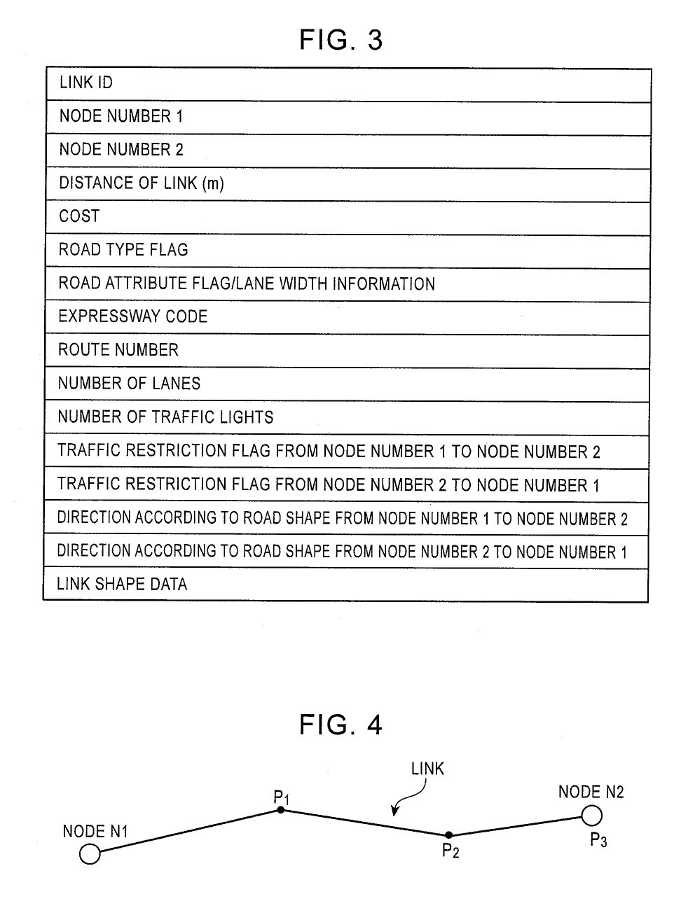

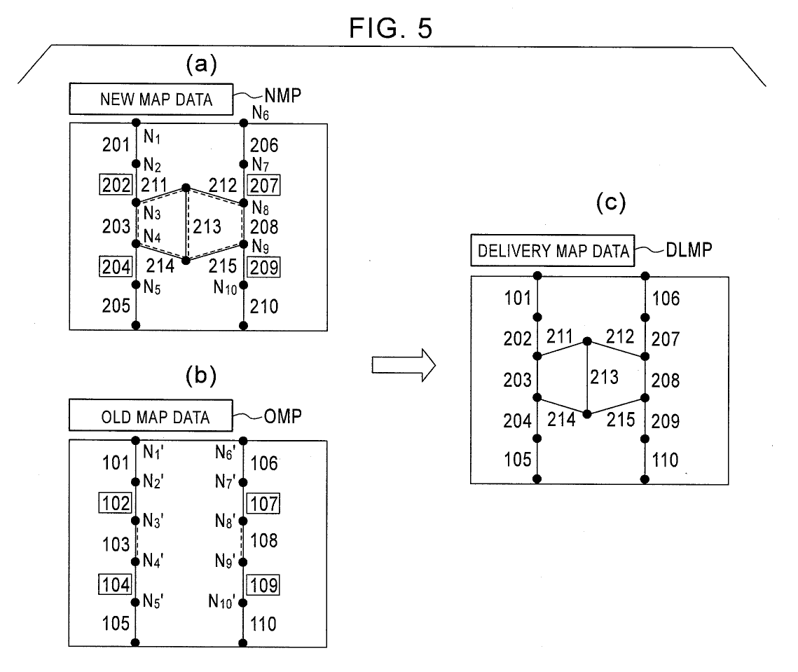

FIG. 3 is a diagram for explaining the link information (the link record) included in the map data for navigation. The link information includes, for each link, (1) a link ID (identifier), (2) node numbers at the opposite ends of the link, (3) the distance of the link, (4) the cost of the link, (5) the type of road, (6) the number of lines, (7) traffic restriction information, (8) shape information for identifying a link shape, and so forth. The link shape represents the shape of the link, as illustrated in FIG. 4, and includes positional data of a start point node, an intermediate node, and an end point node.

(C) Link Information Replacement Process, Link Information Deletion Process, and Link Information Addition Process:

FIG. 5 is another diagram for explaining the link information replacement process, the link information deletion process, and the link information addition process performed by the delivery map creation unit 61a. Specifically, (a), (b), and (c) of FIG. 5 illustrate a road link connection diagram (a road network) of a new map, a road link connection diagram of an old map including the same area as the area of the new map, and a road link connection diagram of a delivery map, respectively. In the road link connection diagram of the new map in (a) of FIG. 5, links 203, 208, 211, 212, 213, 214, and 215 (see links indicated by broken lines) constitute new road constituent links, and links 202, 204, 207, and 209 constitute boundary links connected to the new road constituent links 203, 208, 211, 212, 213, 214, and 215. Further, in (b) of FIG. 5, links 102, 104, 107, and 109 constitute boundary links of the old map, and are physically the same as the boundary links 202, 204, 207, and 209 of the new map, respectively, although the boundary links have different link IDs.

If the boundary links 202, 204, 207, and 209 are identified in the new map, all links 203, 208, 211, 212, 213, 214, and 215 located between the boundary links 202, 204, 207, and 209 can be searched for as the new road constituent links from the link information of the new map data NMP. Further, if the boundary links 102, 104, 107, and 109 are identified in the old map, all links 103 and 108 located between the boundary links 102, 104, 107, and 109 (links indicated by broken lines) can be searched for as the deletion links from the link information of the old map data OMP.

After the completion of the search for the new road constituent links and the deletion links, the delivery map creation unit 61 a first (1) replaces the link information of the boundary links 102, 104, 107, and 109 of the old map data OMP with the link information of the boundary links 202, 204, 207, and 209 of the corresponding new map data NMP. Then, the delivery map creation unit 61 a (2) deletes the link information of the deletion links 103 and 108 from the old map data OMP, and (3) adds the link information of the new road constituent links 203, 208, 211, 212, 213, 214, and 215 to the old map data OMP. From the above-described processes, the delivery map data DLMP illustrated in (c) of FIG. 5 is generated.

(D) Differential Data Creation Device:

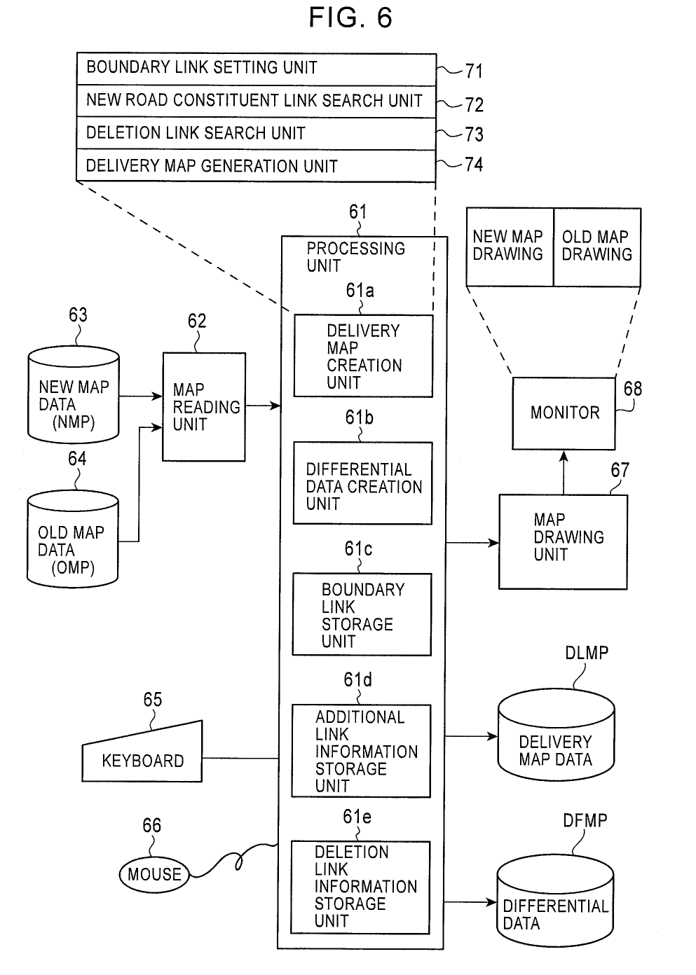

FIG. 6 is a configuration diagram of a differential data creation device according to an embodiment of the present invention. The components of FIG. 6 the same as or similar to the components of FIG. 1, are assigned with the same reference numerals. If the units for creating the differential data are removed from the configuration of FIG. 6, the units for creating the delivery map remain.

A processing unit 61 in implemented using a microcomputer, and includes the delivery map creation unit 61a for creating the delivery map data DLMP, the differential data creation unit 61b for creating the differential data DFMP (which uses the old map data OMP and the delivery map data DLMP), a boundary link storage unit 61c for storing the boundary links, an additional link information storage unit 61d for storing the searched new road constituent links as additional links, and a deletion link information storage unit 61e for storing the searched deletion links.

The delivery map creation unit 61a includes a boundary link setting unit 71, a new road constituent link search unit 72, a deletion link search unit 73, and a delivery map generation unit 74. The boundary link setting unit 71 sets, in the new map, the links not constituting the new road and connected to the new road constituent links as the boundary links, and sets, in the old map, the same links as the boundary links of the new map as the boundary links of the old map. Then, the boundary link setting unit 71 stores the boundary links in the boundary link storage unit 61c. The new road constituent link search unit 72 searches the new map for the links connecting between the boundary links as the new road constituent links, and stores the new road constituent links in the additional link information storage unit 61d. The deletion link search unit 73 searches the old map for the links connecting between the boundary links as the deletion links, and stores the deletion links in the deletion link information storage unit 61e. The delivery map generation unit 74 replaces the link information of the respective boundary links of the old map data OMP with the link information of the respective boundary links of the corresponding new map data NMP, deletes the ink information of the deletion links from the old map data OMP, and adds the link information of the new road constituent links to the old map data OMP, to thereby create the delivery map data DLMP.

The differential data creation unit 61b uses the old map data OMP and the delivery map data DLMP to create the differential data DFMP according to the method described with reference to FIGS. 12 to 14, and passes the differential data DFMP to the navigation device.

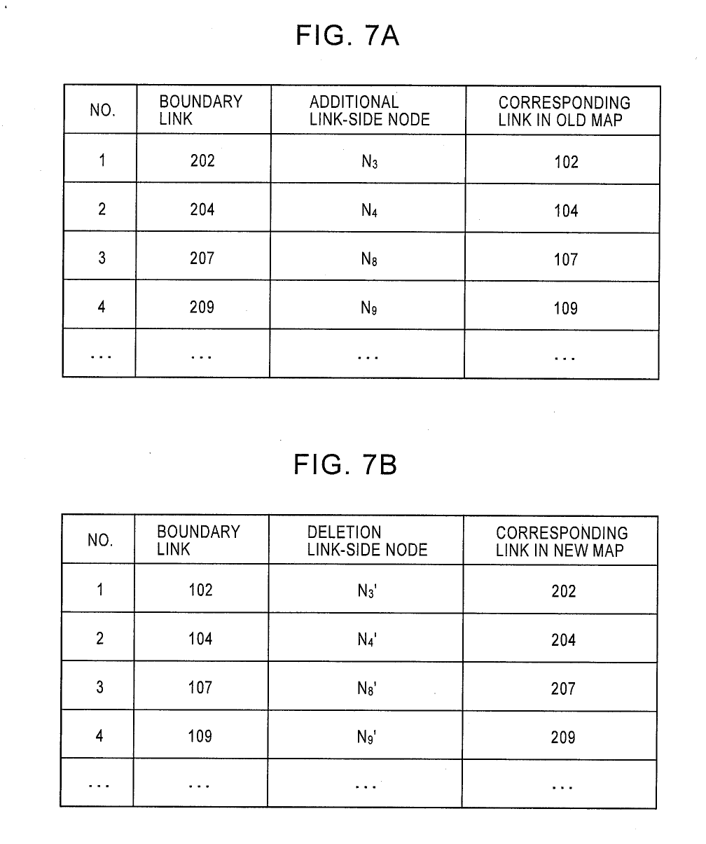

The boundary link storage unit 61c stores boundary link information of the new map and the old map. FIGS. 7A and 7B illustrate examples of the boundary link information stored in the boundary link storage unit 61c, and illustrate the boundary link information of (a) to (c) of FIG. 5 as an example. It is understood from (a) of FIG. 5 that the reference numerals 202, 204, 207, and 209 indicate the boundary links of the new map. Thus, the boundary links 202, 204, 207, and 209 are stored in the boundary link storage unit 61c, as illustrated in FIG. 7A. Further, with respect to the boundary links 202, 204, 207, and 209, node numbers N₃, N₄, N₈, and N₉ at which the boundary links 202, 204, 207, and 209 are connected to the new road constituent links are stored in the boundary link storage unit 61c. Furthermore, the link IDs of the links in the old map the same as the boundary links 202, 204, 207, and 209, i.e., the boundary links 102, 104, 107, and 109 of the old map are stored in the boundary link storage unit 61c. Thus, the matching of the boundary links between the new map and the old map is performed.

Further, it is understood from (a) and (b) of FIG. 5 that the reference numerals 102, 104, 107, and 109 indicate the boundary links of the old map. Thus, the boundary links 102, 104, 107, and 109 are stored in the boundary link storage unit 61c, as illustrated in FIG. 7B. Further, with respect to the boundary links 102, 104, 107, and 109, node numbers N₃′, N₄′, N₈′, and N′₉ at which the boundary links 102, 104, 107, and 109 are connected to the deletion links are stored in the boundary link storage unit 61c. Furthermore, the boundary links 202, 204, 207, and 209 of the new map corresponding to the boundary links 102, 104, 107, and 109 are stored in the boundary link storage unit 61c. Thus, the matching of the boundary links between the new map and the old map is performed.

A map reading unit 62 reads the new map data NMP from a new map storage medium 63, and inputs the new map data NMP in the processing unit 61. The map reading unit 62 further reads the old map data OMP from an old map storage medium 64, and inputs the old map data OMP in the processing unit 61. A keyboard 65 and a mouse 66 are used to input a variety of commands and data in the processing unit 61. The mouse 66 is further used to specify the boundary links on the display screen with the use of a cursor to input the boundary links in the processing unit 61. A map drawing unit 67 uses the new map data NMP and the old map data OMP to generate the road link connection diagram of the new map and the road link connection diagram of the old map, respectively, and displays the road link connection diagrams in juxtaposition on the screen of a monitor 68, for example.

(E) Differential Data Creation Process:

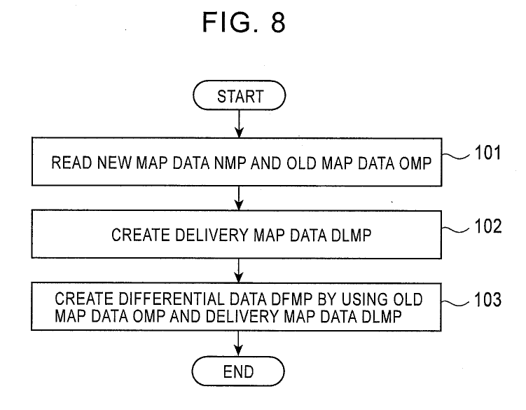

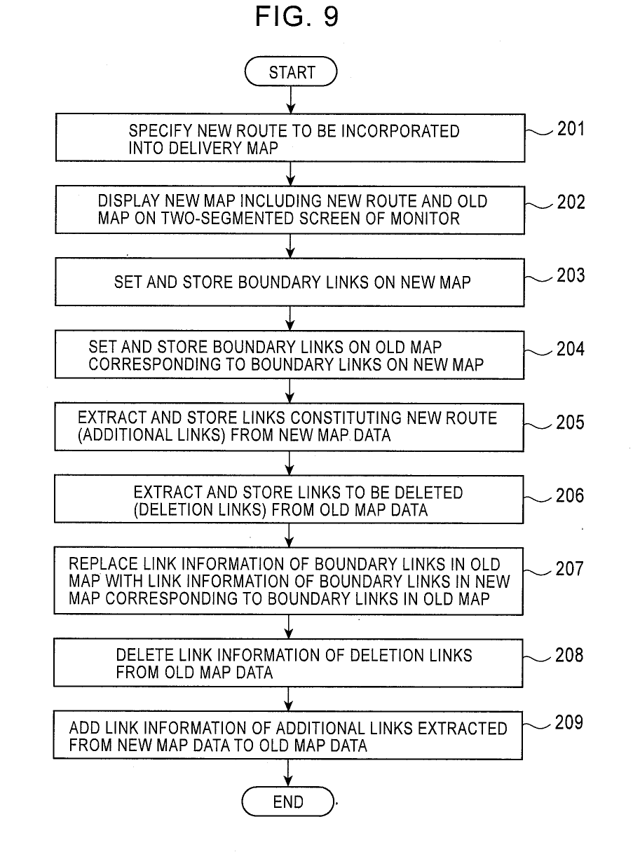

FIG. 8 illustrates the flow of a differential data creation process. First, the map reading unit 62 reads the new map data NMP and the old map data OMP, and inputs the new map data NMP and the old map data OMP in the processing unit 61 (Step S101). Then, in accordance with the process flow illustrated in FIG. 9, the delivery map creation unit 61a of the processing unit 61 creates the delivery map data DLMP by adding the link information relating to a predetermined new road included in the new map data NMP to the old map data OMP (Step S102). Then, according to the method described with reference to FIGS. 12 to 14, the differential data creation unit 61b creates the differential data DFMP by using the old map data OMP and the delivery map data DLMP, and outputs the differential data DFMP (Step S103).

(F) Delivery Map Data Creation Process:

FIG. 9 illustrates the flow of a delivery map data creation process.

In the creation of the delivery map data DLMP, an input is performed to specify one of a plurality of new routes having map data to be incorporated into the old map to create the delivery map data DLMP (Step S201). Accordingly, the delivery map creation unit 61a inputs the predetermined new map data NMP and old map data OMP in the map drawing unit 67. The map drawing unit 67 uses the input new map data NMP to generate the road link connection diagram ((a) of FIG. 5) of the area including the new route (the new road), and uses the input old map data OMP to generate the road link connection diagram ((b) of FIG. 5) of the same area as the above-described area. Then, the map drawing unit 67 displays the road link connection diagrams in juxtaposition on the monitor 68 (Step S202).

Then, with the use of the cursor on the monitor 68, the user inputs the links 202, 204, 207, and 209 connected to the new road constituent links (the links indicated by the broken lines in (a) of FIG. 5) as the boundary links, and inputs the node numbers N₃, N₄, N₈, and N₉ of the boundary links 202, 204, 207, and 209 on the side of the new road constituent links. Thereby, the delivery map creation unit 61a stores the links 202, 204, 207, and 209 in the boundary link storage unit 61c as the boundary links, and also stores the node numbers N₃, N₄, N₈, and N₉ in the boundary link storage unit 61c (FIG. 7A and Step S203).

Then, with the use of the cursor on the monitor 68, the user inputs the links 102, 104, 107, and 109 of the old map, which is the same as the boundary links 202, 204, 207, and 209 of the new map, as the boundary links of the old map corresponding to the boundary links 202, 204, 207, and 209, and inputs the node numbers N₃′, N₄′, N₈′, and N₉′ of the boundary links 102, 104, 107, and 109 on the side of the deletion links. Thereby, the delivery map creation unit 61a stores the links 102, 104, 107, and 109 in the boundary link storage unit 61c as the boundary links of the old map, and also stores the node numbers N₃′, N₄′, N₈′, and N₉′ in the boundary link storage unit 61c (FIG. 7B and Step S204). The delivery map creation unit 61a further stores the correspondence relationship between the boundary links 202, 204, 207, and 209 of the new map and the boundary links 102, 104, 107, and 109 of the old map in the boundary link storage unit 61c.

After the completion of the process of setting the boundary links, the delivery map creation unit 61a uses the new map data NMP to search for the links 203, 208, 211, 212, 213, 214, and 215 connecting between the boundary links 202, 204, 207, and 209 as the new road constituent links (the additional links), and stores the new road constituent links 203, 208, 211, 212, 213, 214, and 215 in the additional link information storage unit 61d (Step S205). Further, the delivery map creation unit 61a uses the old map data OMP to search for the links 103 and 108 connecting between the boundary links 102, 104, 107, and 109 as the deletion links, and stores the deletion links 103 and 108 in the deletion link information storage unit 61e (Step S206).

After the completion of the search for the new road constituent links (the additional links) 203, 208, 211, 212, 213, 214, and 215 and the deletion links 103 and 108 through the above-described processes, the delivery map creation unit 61 a replaces the link information of the respective boundary links 102, 104, 107, and 109 of the old map data OMP with the link information of the respective boundary links 202, 204, 207, and 209 of the corresponding new map data NMP (Step S207), deletes the link information of the deletion links 103 and 108 from the old map data OMP (Step S208), and adds the link information of the new road constituent links 203, 208, 211, 212, 213, 214, and 215 to the old map data OMP (Step S209). Thereby, the creation of the delivery map data DLMP is completed.

(G) New Road Constituent Link (Additional Link) Acquisition Process:

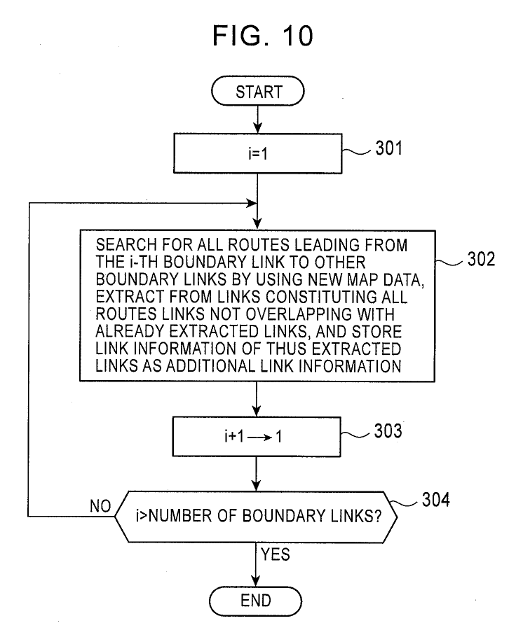

FIG. 10 illustrates the flow of the process of acquiring the new road constituent links (the additional links) performed at Step S205 of FIG. 9. The delivery map creation unit 61a first sets an equation i=1 (Step S301). Then, the delivery map creation unit 61a searches for all routes leading from the i^{th} boundary link to the other boundary links by using the new map data NMP, extracts from the links constituting the routes links not overlapping with already extracted links, and stores the link information of the extracted links in the additional link information storage unit 61d as additional link information (Step S302). Then, the delivery map creation unit 61a performs an iterative operation on the value i through an operation i+1→1 (Step S303), and checks if the value i exceeds the number of the boundary links (Step S304). If the value i does not exceed the number of the boundary links, the delivery map creation unit 61 a repeats the processes of Step S302 and the subsequent steps. If the value i exceeds the number of the boundary links, the delivery map creation unit 61a completes the process of acquiring the new road constituent links (the additional links).

(H) Deletion Link Acquisition Process:

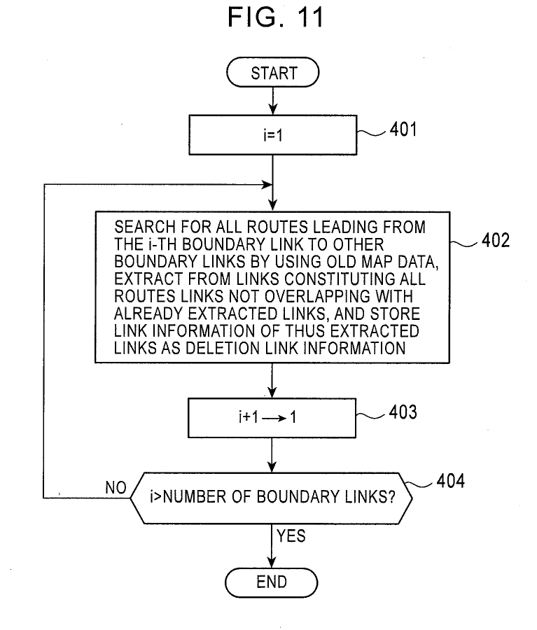

FIG. 11 illustrates the flow of the process of acquiring the deletion links performed at Step S206 of FIG. 9. The delivery map creation unit 61a first sets the equation i=1 (Step S401). Then, the delivery map creation unit 61a searches for all routes leading from the i^{th} boundary link to the other boundary links by using the old map data OMP, extracts from the links constituting the routes links not overlapping with already extracted links, and stores the link information of the thus extracted links in the deletion link information storage unit 61e as deletion link information (Step S402). Then, the delivery map creation unit 61 a performs an iterative operation on the value i through the operation i+1→1 (Step S403), and checks if the value i exceeds the number of the boundary links (Step S404). If the value i does not exceed the number of the boundary links, the delivery map creation unit 61a repeats the processes of Step S402 and the subsequent steps. If the value i exceeds the number of the boundary links, the delivery map creation unit 61a completes the process of acquiring the deletion links.

Although only a few exemplary embodiments have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. A delivery map creation method for creating delivery map data by adding link information relating to a predetermined new road included in new map data, to old map data, the method comprising:
setting, in a new map, links not constituting the new road and connected to links constituting the new road as boundary links, and setting, in an old map, the same links as the boundary links of the new map as boundary links of the old map;
searching, in the new map, for links connecting between the boundary links as new road constituent links;
searching, in the old map, for links connecting between the boundary links as deletion links; and
replacing link information of the respective boundary links of old map data with link information of the respective boundary links of the corresponding new map data,
deleting link information of the deletion links from the old map data, and
adding link information of the new road constituent links to the old map data.

2. The delivery map creation method according to claim 1, wherein setting the boundary links includes
setting the boundary links of the new map and displaying an area including the new road on a display screen by using the new map data, and specifying predetermined links on the display screen, and
setting the boundary links of the old map by displaying the area on the display screen by using the old map data, and specifying predetermined links on the display screen.

3. The delivery map creation method according to claim 2, wherein
the area of the new map and the area of the old map are displayed in juxtaposition on the display screen by using the new map data and the old map data, respectively.

4. The delivery map creation method according to claim 1, wherein
searching for the new road constituent links includes
searching for all routes leading from each of the boundary links of the new map to other boundary links by using the new map data, and
searching for the new road constituent links by extracting the new road constituent links from links constituting the respective routes wherein overlapping of the extracted links is prevented.

5. The delivery map creation method according to claim 1, wherein
searching for the deletion links includes
searching for all routes leading from each of the boundary links of the old map to other boundary links with the use of the old map data, and
searching for the deletion links by extracting the deletion links from links constituting the respective routes, wherein overlapping of the extracted links is prevented.

6. The delivery map creation method according to claim 1, wherein
setting the boundary links of the new map identifies, based on nodes at opposite ends of the boundary links, nodes on a side of the new road constituent links, and
wherein searching for the new road constituent links includes searching for links connecting between the identified nodes of the boundary links as the new road constituent links.

7. The delivery map creation method according to claim 1, wherein
setting the boundary links of the old map identifies, based on nodes at opposite ends of the boundary links, nodes on a side of the deletion links, and
wherein searching for the deletion links includes searching for links connecting between the identified nodes of the boundary links as the deletion links.

8. A differential data creation method used to update old map data to new map data, the method comprising:
creating delivery map data by adding link information relating to a predetermined new road included in the new map data, to the old map data; and
creating differential data by identifying an old map data portion in which the delivery map data matches the old map data and identifying a delivery map data portion which is absent in the old map data,
wherein creating the delivery map data includes
setting, in a new map, links not constituting the new road and connected to links constituting the new road as boundary links, and setting, in an old map, the same links as the boundary links of the new map as boundary links of the old map,
searching, in the new map, for links connecting between the boundary links as new road constituent links,
searching, in the old map, for links connecting between the boundary links as deletion links, and
replacing link information of the respective boundary links of the old map data with link information of the respective boundary links of the corresponding new map data,
deleting link information of the deletion links from the old map data, and
adding link information of the new road constituent links to the old map data, to thereby create the delivery map data.

9. A delivery map creation device for creating delivery map data by adding link information relating to a predetermined new road included in new map data, to old map data, the device comprising:
a boundary link setting unit for setting, in a new map, links not constituting the new road and connected to links constituting the new road as boundary links, and setting, in an old map, the same links as the boundary links of the new map as boundary links of the old map;
a new road constituent link search unit for searching, in the new map, for links connecting between the boundary links as new road constituent links, and storing the new road constituent links;
a deletion link search unit for searching, in the old map, for links connecting between the boundary links as deletion links, and storing the deletion links; and
a delivery map generation unit for creating a delivery map by replacing link information of respective boundary links of the old map data with link information of the respective boundary links of the corresponding new map data, deleting link information of the deletion links from the old map data, and adding link information of the new road constituent links to the old map data.

10. The delivery map creation device according to claim 9,
wherein the boundary link setting unit sets the boundary links of the new map by displaying an area including the new road on a display screen by using the new map data and specifying predetermined links on the display screen, and sets the boundary links of the old map by displaying the area on the display screen by using the old map data and specifying predetermined links on the display screen.

11. The delivery map creation device according to claim 10,
wherein the boundary link setting unit displays the area of the new map and the area of the old map in juxtaposition on the display screen by using the new map data and the old map data, respectively.

12. The delivery map creation device according to claim 9,
wherein the new road constituent link search unit searches for all routes leading from each of the boundary links of the new map to other boundary links by using the new map data, and searches for the new road constituent links by extracting the new road constituent links from links constituting the respective routes, wherein overlapping of the extracted links is prevented.

13. The delivery map creation device according to claim 9,
wherein the deletion link search unit searches for all routes leading from each of the boundary links of the old map to other boundary links with the use of the old map data, and searches for the deletion links by extracting the deletion links from links constituting the respective routes, wherein overlapping of the extracted links is prevented.

14. The delivery map creation device according to claim 9,
wherein the boundary link setting unit identifies, based on nodes at opposite ends of the boundary links, nodes on the side of the new road constituent links, and
wherein the new road constituent link search unit searches for links connecting between the identified nodes of the boundary links as the new road constituent links.

15. The delivery map creation device according to claim 9,
wherein the boundary link setting unit identifies, based on nodes at opposite ends of the boundary links, nodes on the side of the deletion links, and
wherein the deletion link search unit searches for links connecting between the identified nodes of the boundary links as the deletion links.

16. A differential data creation device used to update old map data to new map data, the device comprising:
a delivery map creation unit for creating delivery map data by adding link information relating to a predetermined new road included in the new map data, to the old map data; and
a differential data creation unit for creating differential data by identifying an old map data portion in which the delivery map data matches the old map data and by identifying a delivery map data portion which is absent in the old map data,
wherein the delivery map creation unit includes
a boundary link setting unit for setting, in a new map, links not constituting the new road and connected to links constituting the new road as boundary links, and setting, in an old map, the same links as the boundary links of the new map as boundary links of the old map,
a new road constituent link search unit for searching, in the new map, for links connecting between the boundary links as new road constituent links, and storing the new road constituent links,
a deletion link search unit for searching, in the old map, for links connecting between the boundary links as deletion links, and storing the deletion links, and
a delivery map generation unit for creating a delivery map by
replacing link information of the respective boundary links of old map data with link information of the respective boundary links of the corresponding new map data,
deleting link information of the deletion links from the old map data, and
adding link information of the new road constituent links to the old map data.
